(19) United States
(12) Patent Application Publication
(10) Pub. No.: US 2024/0427845 A1
(43) Pub. Date: Dec. 26, 2024

(54) FEATURE VECTOR BINARIZATION

(71) Applicant: SILVERARROW AI, INC., Schaumburg, IL (US)

(72) Inventors: Mark D. Hetherington, Crystal Lake, IL (US); Jorn Lyseggen, London (GB)

(73) Assignee: SILVERARROW AI, INC., Schaumburg, IL (US)

(21) Appl. No.: 18/752,703

(22) Filed: Jun. 24, 2024

Related U.S. Application Data
(60) Provisional application No. 63/510,097, filed on Jun. 23, 2023.

(51) Int. Cl. G06F 17/16

(52) U.S. Cl. CPC G06F 17/16

(57) ABSTRACT

A method includes identifying a feature vector with N features to transform into M bits. The feature vector including one or more values, where each value corresponds to a characteristic of an object. The method includes applying a transform to the feature vector to create a transformed feature vector. The method further includes quantizing the transformed feature vector to generate a binarized feature vector of M bits.

### CROSS REFERENCE TO RELATED APPLICATIONS

This U.S. patent application claims priority to Provisional Patent Application 63/510,097 filed on Jun. 23, 2023. The disclosure of this prior application is considered part of the disclosure of this application and is hereby incorporated by reference in its entirety.

### TECHNICAL FIELD

This disclosure relates to a method of feature vector binarization and binary distance transform.

### BACKGROUND

With modern advancements in technology, data is being created at a significant rate. As the amount of data increases, there becomes an increasing need to efficiently search that data. In data science, some techniques, referred to as “nearest neighbor” can be used for a wide number of fields, including in biometrics, image and location recognition, machine learning, media recommendations, among many, many more use cases.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

One aspect of the disclosure provides a method that includes identifying a feature vector with N features to transform into M bits. The feature vector including one or more values, where each value corresponds to a characteristic of an object. The method includes applying a transform to the feature vector to create a transformed feature vector. The method further includes quantizing the transformed feature vector to generate a binarized feature vector of M bits.

A system can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method. The method also includes identifying a feature vector with n features to transform into m bits, the feature vector including a plurality of values, each value of the plurality of values corresponding to a characteristic of an object. The method also includes applying a transform to the feature vector to create a transformed feature vector. The method also includes quantizing the transformed feature vector to generate a binarized feature vector of m bits; and storing, in an electronic data storage, the binarized feature vector.

Implementations may include one or more of the following features. The method may include adjusting a number of dimensions of the feature vector to m dimensions. Adjusting the number of dimensions of the feature vector to m dimensions includes appending one or more padding features to the feature vector. Applying the transform to the feature vector includes applying the transform to the m dimensional feature vector that includes the n features of the feature vector and one or more padding features. The number of dimensions of the feature vector is increased to m dimensions prior to applying the transform to the feature vector. Applying the transform to the feature vector to create the transformed feature vector includes applying multiple transforms. Applying the transform to the feature vector includes applying the transform to each value of the plurality of values to provide a plurality of transformed feature values, the transformed feature vector including the plurality of transformed feature values, where the quantizing yields one bit for each transformed feature value. The quantizing yields more than one bit for each transformed feature value. The vector length to be used to perform an inverse transfer function to reconstruct an approximation of the feature vector as the feature vector existed prior to the transform. The transform is selected from a group of transforms in view of at least one of a vector size or an entropy resolution. N equals 1. Implementations of the described techniques may include hardware, a method or process, or computer software on a computer-accessible medium.

Another aspect includes a system. The system also includes one or more processors; and a memory may include instructions that, when executed by the one or more processors, cause the system to perform operations may include: identify a feature vector with n features to transform into m bits, the feature vector including a set of values, each value of the set of values corresponding to a characteristic of an object: apply a transform to the feature vector to create a transformed feature vector: quantize the transformed feature vector to generate a binarized feature vector of m bits; and cause the binarized feature vector to be stored electronically.

Implementations may include one or more of the following features. The system where the feature vector is associated with a feature space, the feature space being a dimensional space may include one or more of dimensions, the feature space having n axes, each feature of the n features being represented as a point in the feature space with respect to the n axes. The feature vector is an n-dimension feature vector, the operations further including to add another dimension to the feature vector to result in a higher-dimension feature vector, where the transform is applied to the higher-dimension feature vector. When adding the another dimension to the feature vector, the system is to add a padding to the feature vector, where the padding includes a zero value, where the applying the transform to the n-dimension vector results in the zero value transforming to a non-zero value. When adding the another dimension to the feature vector, the system is to apply multiple transforms to the feature vector. N equals 1. N is greater than one, where when adding the another dimension to the feature vector, the system is to: define a first sub-vector and a second sub-vector from the feature vector: apply a first transform to the first sub-vector to create a transformed first sub-vector: apply a second transform to the second sub-vector to create a transformed second sub-vector; and combine the transformed first sub-vector and the transformed second sub-vector to create the transformed feature vector having length m. The operations may include to determine a vector length of the feature vector, where the vector length to be used to perform an inverse transfer function to reconstruct the feature vector as the feature vector existed prior to the transform.

A further aspect includes a non-transitory machine-storage medium embodying instructions that. The non-transitory machine-storage medium embodying instructions also includes identify a feature vector with n features to transform into m bits, the feature vector including a plurality of values, each value of the plurality of values corresponding to a characteristic of an object. The instructions also includes apply a transform to the feature vector to create a transformed feature vector. The instructions also includes quantize the transformed feature vector to generate a binarized feature vector of m bits. The instructions also includes cause the binarized feature vector to be stored electronically.

Implementations may include one or more of the following features. The non-transitory machine-storage medium where the feature vector includes one or more dimensions, the operations further including to add another dimension to the feature vector. The feature vector is a sub-vector that is one part of a larger feature vector.

Implementations of the described techniques may include hardware, a method or process, or computer software on a computer-accessible medium.

### DESCRIPTION OF DRAWINGS

Example implementations will be described and explained with additional specificity and detail through the use of the accompanying drawings in which:

FIG. 1 illustrates a schematic view of an example system configured to generate a binarized feature vector, B, from a source feature vector, F, by applying a transform and a quantization.

FIG. 2 illustrates a schematic view of an example system for generating an M-bit binarized feature vector from a source feature vector of length N using an N×N transform and quantization.

FIG. 3 illustrates a schematic view of an example method for generating a binarized feature vector with M binary features from a source feature vector having N features, where N is less than M.

FIG. 4 illustrates a schematic view of an example method for converting M binary features to an approximation of a source feature vector, F′, with N floating point features.

FIG. 5 illustrates a schematic view of an example system for generating M binary features using multiple transforms and/or quantization from N floating point features.

FIG. 6 illustrates a schematic view of an example system for converting M binary features-n to N floating point features using multiple transforms.

FIG. 7A illustrates an example projection of a feature vector from a lower dimension coordinate system onto a single higher dimension coordinate system.

FIG. 7B illustrates a 2 dimensional example of the same feature of FIG. 7A being projected onto two different coordinate axes.

FIG. 8 illustrates an example diagram for using a search vector in view of a vector database of vectors to determine one or more distances.

FIG. 9 illustrates a schematic view of an example system for performing a two-stage search of a vector database.

FIG. 10 illustrates a flowchart of an example method of performing binary distance transform, in accordance with at least one embodiment of the present disclosure.

FIG. 11 example process for determining the mapping between the first distance and the second distance.

FIG. 12 illustrates a diagrammatic representation of a machine in the example form of a computing device within which a set of instructions, for causing the machine to perform any one or more of the methods discussed herein, may be executed.

FIG. 13 illustrates a diagram of an example mapping function.

Like reference symbols in the various drawings indicate like elements.

### DETAILED DESCRIPTION

In machine learning and pattern recognition, a feature vector is an n-dimensional vector of numerical features that represent an object. A feature, for example, may include an individual measurable property or characteristic of the object. Any object can be characterized using a feature vector. Examples of objects that can be characterized using a feature vector include any tangible object, property, characteristic, attribute, etc.

Feature vectors are typically created by various classification or feature extraction algorithms. Feature vectors are usually a series of floating point or integer values that represent the characteristics of an object. An object can be anything, including images, audio, text, or any real measureable quantity. Two objects can be compared to see how similar or different they are by computing a distance measurement between their respective feature vectors.

New objects are often compared against large databases of previously recorded samples to find samples that have similar characteristics. In conventional systems, it is important that the match process is fast, especially as the database size grows. As the amount of data in a data set increases, performing operations on that data set (e.g., matching, searching, comparing, etc.) becomes more difficult, can take more time, can increase in cost, and can consume more power. Also, with more complicated features, feature vectors can be more complex, making them even more difficult to efficiently compare.

Artificial intelligence and/or machine learning systems may benefit from the use binarized feature vectors, such as to improve match speeds or reduce feature storage sizes. In such systems, it is sometimes preferable that each bit is independent of every other bit so that Hamming distance can then be used as a measure of similarity. In some embodiments, the independence of the bits may refer to there being no structural connection between bits so that the bits can each experience an error without creating errors in other bits. The complexity of the Hamming distance measurement is significantly less than for Euclidean distance, L2 norm or Cosine similarity, which can result in much faster speeds for match algorithms.

Typical binary encodings of integer features or quantized floating point features, however, do not perform well with Hamming distance. Special encoding techniques, such as Gray Codes can be used to ensure that the Hamming distance between neighboring quantization values is always 1. However, these techniques do not preserve the relative distance relationship between quantization values of non-neighbors which can significantly reduce comparison accuracy and performance. Moreover, another significant drawback with prior approaches is that with these encodings, bits are not able to vary independently of each other.

Aspects of the present disclosure address these and other shortcomings of prior approaches by providing improvements related to feature vector binarization. With the disclosed feature vector binarization, features can be represented by bits that can vary independent of each other. In some embodiments, features can be sign quantized (e.g., to 1 bit per feature). Further, actual distances between vectors can be preserved and real differences in feature values can be ascertained. For example, if Fᵢ>T, Bᵢ=1, else Bᵢ=0 where Fᵢ is the ith feature and Bᵢ is the ith binary feature. T can be any value that creates a separation with some values greater than and some less than T. An example of T may include a mean or median value of the feature, but other values could provide some advantage, such as if multiple binary quantizations on the same feature are used. Using the disclosed techniques, bits may now vary independently and may be better suited for Hamming Distance comparison. However, in many cases, even Hamming Distance comparison may produce a significant loss in the entropy contained in the original floating point feature values. As a result, less information is retained, so the accuracy of the similarity measurement may suffer.

To reduce these negative effects of conventional Hamming Distance comparison between samples, and to reduce the loss of entropy caused by single bit encoding, projecting the original features onto an additional alternative coordinate system provides an additional view of the feature vector. Quantizing the projected features along with the original features provides additional resolution of the feature entropy that will generally recover some of the lost entropy that may be caused by a quantizer (a 1-bit quainter, or a multi-bit quantizer). More projections can be added to further resolve the feature entropy at the expense of larger binary feature vectors and longer match times.

Techniques described herein can provide significant improvement in computer processing speed, provide reductions in power consumption, and can overall performance of artificial intelligence. Further details of the disclosure are provided herein.

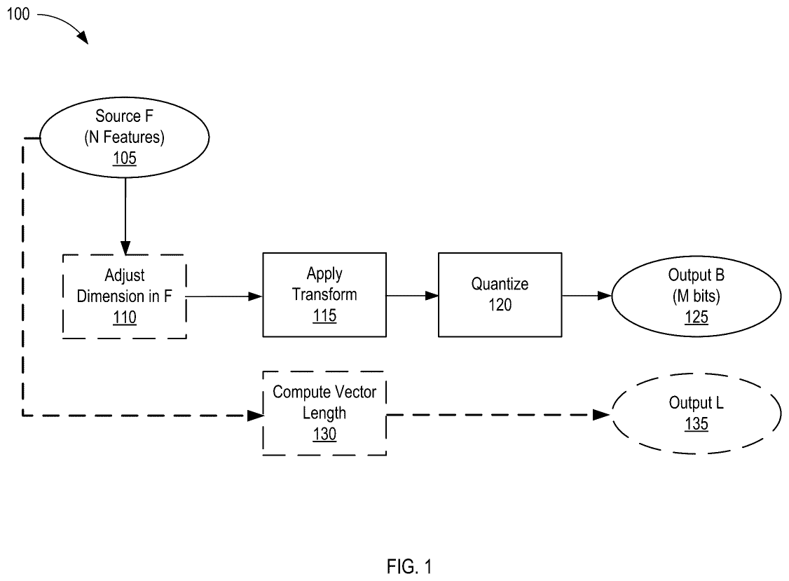

FIG. 1 illustrates a schematic view of an example system 100 configured to generate a binarized feature vector, B, 125 from a source feature vector, F, 105 by applying a transform 115 and a quantization 120. For example, the example system 100 may generate the binarized feature vector by converting N features into M bits. The M bits may be arranged together, for example, as a bit pattern. Once the binarized feature vector 125 is generated, further computer-related operations may be performed on the M bits, such as a query, compare, etc.

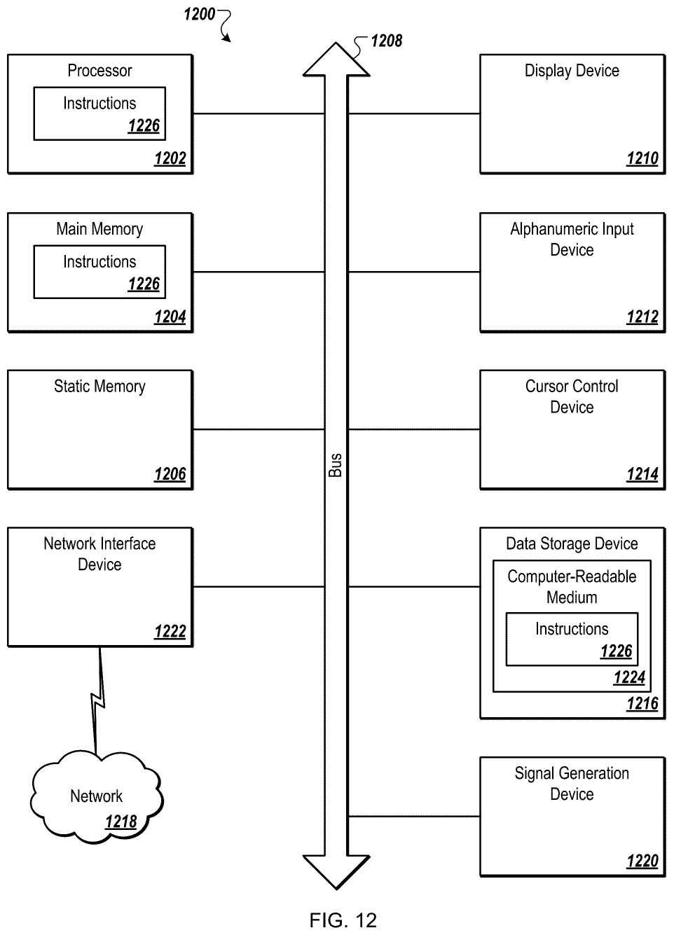

The example system 100 can be any computer-based system with one or more processors and a storage device, including a memory, cache, etc., including the system 1200 further described in conjunction with FIG. 12. The system 100 may identify the source feature vector 105, which may have N features, where N may be any number equal to or greater than 1.

At block 105, the system 100 may identify a feature vector with N features to transform into M bits. In some instances, the source feature vector, F, 105 may be referred to as an original feature vector, an input feature vector, an initial feature vector, etc. The source feature vector may include a set of values, where each value of the set of values may correspond to a characteristic of an object. The object may be a characteristic of anything that can be represented numerically, including but not limited to digital objects (e.g., pictures, videos, files) physical places (such as a city, state, a room in a building), a concept (e.g., happiness, anxiety), a profession (e.g., entrepreneur, architect). In some instances, an arbitrary value is assigned to a particular concept such that the presence of that concept in the feature vector is represented using the respective assigned number. In some instances, a position in the vector may correspond to a color of a vehicle, with different values in that position representing different colors. In other embodiments, a different position in the same feature vector may correspond to a vehicle wheel selection, with different values representing different wheel options. In yet a further example, a positon in a feature vector may represent a human feeling or emotion, with a different value for each feeling, such as happy, sad, angry, excitement, etc. Each position in the source feature vector 105 may be referred to as a dimension. In some embodiments, the dimensions of the feature vector may include a count of rows or columns. The dimensions of the source feature vector may also be a count of the floating point features of the source feature vector.

In some embodiments, N is greater than M and the system 100 can increase the number of dimensions by an amount of dimensions equal to M minus N. For example, when M is equal to 2 and N is equal to 1, then the amount of dimensions to add is 1. In some embodiments, when increasing the number of dimensions to the source feature vector 105, the system 100 can append padding to the source feature vector 105. In some embodiments, padding can be added anywhere to the source feature vector 105 including at the beginning, middle and/or end. In some embodiments, when adding more than one padding, the added padding can be added next to each other, or can be added with non-neighboring placement.

In some embodiments, N is equal to M. In such embodiments, block 110 to increase dimensions 110 of the source feature vector may not be performed.

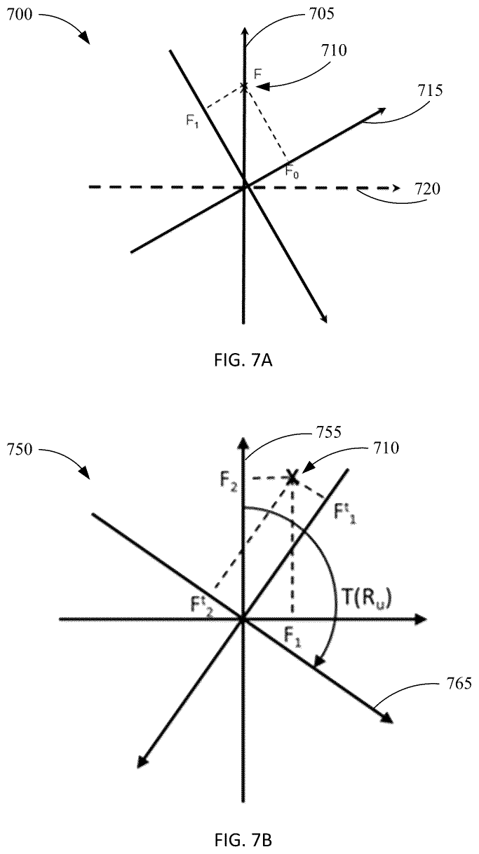

In some embodiments, N is less than M where the adjustment to the number of dimensions of the source feature vector 105 is a reduction in dimensions. In such embodiments, the system 100 can produce a binarized feature vector 125 that has fewer bits than the source feature vector 105 had dimensions. In some embodiments, the dimensions of the source feature vector may be increased by a projecting the source feature vector onto an additional alternative higher-dimension coordinate system. Some example projection techniques for increasing dimensions are further described in conjunction with FIGS. 7A and 7B.

The system 100 can apply a transform 115 to the source feature vector to create a transformed feature vector. When features are added to or removed from the feature vector 105 in 110, then the transform may be applied to that resulting feature vector with the added dimension(s)/padding. In some embodiments, the transform 115 can be an M×M transform. The M×M transform may be predefined. In some embodiments, the transform 115 can be an N×M. In general, a padding part of the transformation can be pre-computed for all vectors since this may not change from vector to vector. This pre-computation can become a bias per output value. In instances a padding value of “0” is used, the bias will be zero. The pre-computation, for example, can further improve storage and computational efficiency.

The system 100 can quantize the transformed feature vector to generate a binarized feature vector of M bits. In some embodiments, the quantization may be 1-bit quantization such that there is 1 bit for each feature, which may result in a total of N total bits. Quantizing can be performed for each feature in the transformed feature vector. For example, when a feature in the feature vector is a numerical value, quantizing each feature may include replacing the numerical value with a different numerical value. Quantization may include mapping the one value to another value, for example. Quantization may also include rounding, truncating, reassigning, etc.

The system 100 can cause the binarized feature vector to be stored electronically, such as in a local or remote storage medium including in a temporary memory and/or cache.

Optionally, the system 100 may identify a length of the source feature vector 105 a block 130. For example, the length may be indicative of a number of features in the source feature vector 105. The length, L, 135 may be output to a storage, which may also include associating the length 135 with a record related to the source feature vector 105.

In some embodiments, padding and transforms may be iteratively tested to affect speed, accuracy, entropy resolution, etc. such that a balance may be achieved. In some embodiments, an output comparison may be performed to analyze parameters for the feature vector binarization. In some embodiments, a transform function may be selected through a selection process, such as by sampling a vector, performing a transform on the vector, then looking at error in an inverse transform. As an error value decreases for a particular transform as compared to other transforms, that particular transform may be selected to handle the transform process.

In some embodiments, different vectors and/or transforms may be used for different customers, different end users, etc., which can provide greater security, as an interception of vectors and/or transform, may not be applied nefariously to data of others. In essence, a small data breach may not spoil data for all.

Further, using different vectors and/or transforms may be used for access control. For example, in a company with different departments, each department may use different vectors and/or transforms so the data in different departments may not be allowed to be shared between departments. A data or security hierarchy may be achieved with the present disclosure, including a permissions model, classification, etc.

In some embodiments, the transform and quantization processes described herein may be reversible with some amount of added quantization error. This quantization error may be due in part to the vector length, e.g. distance from the origin, being lost during the binarization process. Reversal from the binary features produces the relative shape of the feature vector, but the magnitude information may be lost.

To mitigate or in some cases, to reduce or eliminate the quantization error that may be present, reversal or reconstruction may be achieved by storing and keeping track of the vector length. If reversal from binary features to floating point features is to be performed, the vector length of the source feature vector can be stored with the binary features. While the vector length is illustrated as a floating point value, the vector length can also be scalar quantized in some manner, for example fixed quantization intervals or statistically optimal intervals. This can be used to recover the correct vector length after the inverse transform is applied.

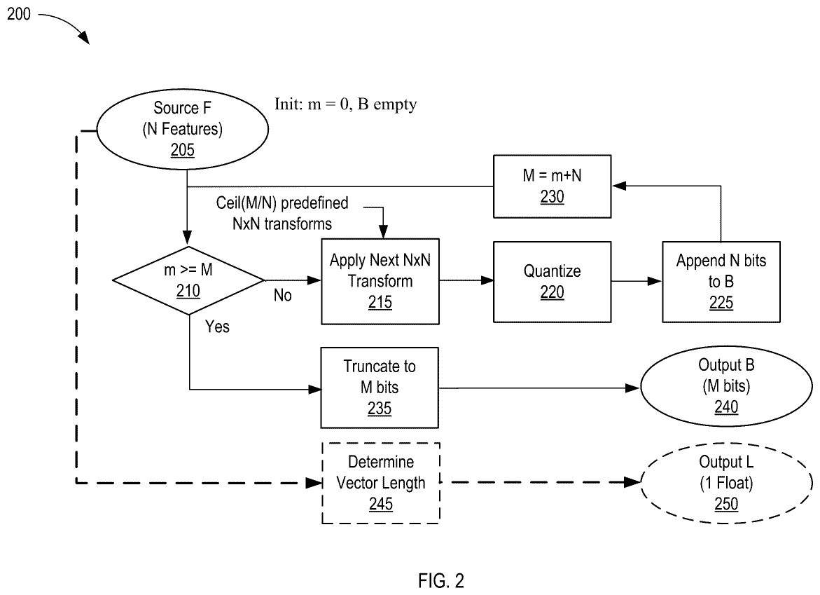

FIG. 2 illustrates a schematic view of an example system 200 for generating an M-bit binarized feature vector 240 from a source feature vector 205 of length N using an N×N transform 215 and quantization 220. In some embodiments, the system 200 may use multiple transform blocks to convert N features into M bits. In some embodiments, when using multiple transforms, the multiple N×N transforms may be different for each block to provide entropy refinement. For example, if the multiple N×N transforms are not different for each block then the added features will match the original features and may not add any entropy refinement value.

A source feature vector 205 with N features may be provided to the system 200. A counter, m, may be set to zero. When m=0, then a bit sequence, B, may be empty. Block 210 is a decision point. If m is not greater than or equal to M (e.g., while the counter is less than the number of M bits) a block 210, then a next N×N transform may be applied to the source feature vector 205 at block 215.

In applying the transformation, the actual transformations chosen can vary and may be either orthogonal or non-orthogonal. Transforms may be linear or non-linear and can involve translation, rotation, scaling, skewing, etc. For multiple transforms, even though the transforms can be arbitrarily chosen, the transformation process may be fixed and repeatable for all vectors that will be compared to each other. The exact transformation can typically be chosen arbitrarily as long as they are applied in the same way for all feature vectors that will be compared to each other. Transforms can be modified based on a user key or an application key. There may be a mapping between the key value and a unique transformation that it represents. In some embodiment, the key may be used to seed a pseudo-random number generator which is used to create the mapping from key to transform, but any unique mapping approach may also be applied. In some embodiments, a transform may refer to a collection of basis vectors. In some embodiments, a set of vectors (any number of vectors, any collection of vectors, or any collection of arbitrary vectors) can be referred to as a transform. Additionally or alternatively, some transform techniques may use algorithms and/or projections onto vectors without specifically grouping them into a “transform”, but the effect can be similar as for embodiments that use a set of vectors. Projection can be a non-orthogonal transform.

Different transforms can be chosen which will give different binary outputs. In some embodiments, a particular transform may be selected to provide a particular amount of entropy resolution. In some embodiments, an amount of padding may be selected to optimize the trade-off between binary feature vector size and entropy resolution to meet the needs of a particular application.

In some embodiments, the rows and/or columns of the same transform can be swapped to give different outputs. Swapping rows and/or columns may not affect any existing orthogonality property of the transform. Reordering columns may be equivalent to reordering the input features. Reordering columns may be equivalent to reordering the output features. The reordering process can also be tied to a key such that the row and column ordering are determined by a unique mapping between the key and the row/column arrangement.

In some embodiments with multiple transforms, there may be multiple N×N transforms where N=1 (e.g., a 1×1 transform applied to each individual feature). N can be any number including N=1. In an example, applying two 1×1 transforms per feature may create 2 bits per feature while 1×1 scaling may be 1.0 for both transforms with different origins.

Then at block 220, a quantization 220 may be used to quantize the transformed feature vector 205. In some embodiments, the quantization may be 1-bit quantization such that there is 1 bit for each feature, which may result in a total of N total bits. Then at block 225, the N bits are appended to an initially empty B, which may be (or may later become) a binary representation 240 of the source feature vector 205.

While m is not greater than or equal to M at block 210, then the process may continue until m is greater than or equal to M. If m is equal to M, then B is output as M bits. If m is greater than M, then B is truncated to M bits and output with M bits. In some embodiments, M is a multiple of N. In some embodiments, M is not a multiple of N and in these embodiments, M may be truncated such that the number of bits in M equals the number of bits in N, or such that the number of bits in M is a multiple of the number of bits in N.

In some embodiments, a vector length of the source feature vector, F, is determined at block 245. The vector length 250 may be stored and/or or output as L. Vector length may refer to as being a distance from the origin, with some examples described in conjunction with FIGS. 7A and 7B. In some embodiments, vector length, L, may be calculated with the expression: L=sqrt(sum_i(Fi*Fi)) where Fᵢ is the value of the ith feature and sum_i is a summation over all features in the feature vector.

In some embodiments, the techniques described herein could be used for portions of a source feature vector. For example, when adding another dimension to the source feature vector an operation of method may include defining a first sub-vector and/or a second sub-vector from a feature vector. Next, a first transform may be applied to the first sub-vector to create a transformed first sub-vector. A second transform may be applied to the second sub-vector to create a transformed second sub-vector. The transformed first sub-vector and the transformed second sub-vector may be combined to create a transformed feature vector having length M.

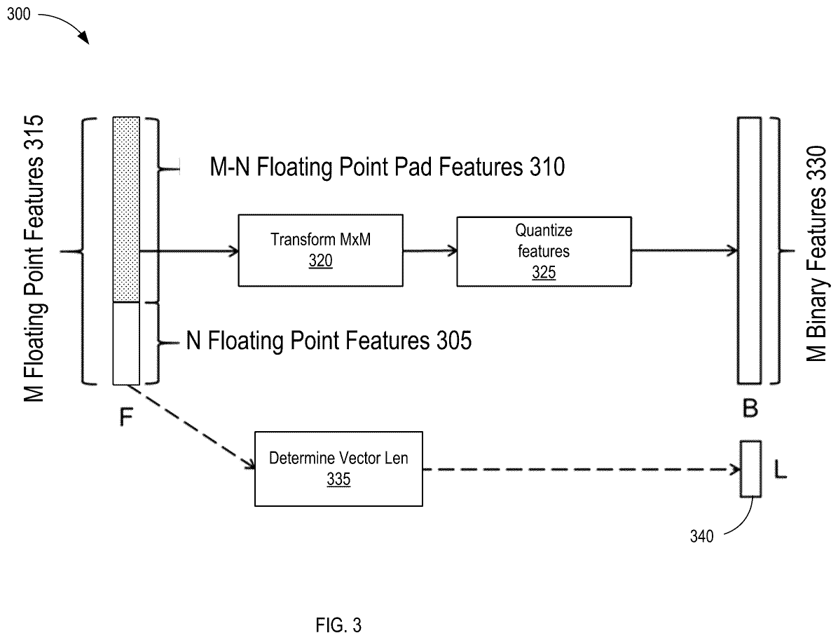

FIG. 3 illustrates a schematic view of an example method 300 for generating a binarized feature vector 330 with M binary features from a source feature vector having N features 305, where N is less than M. The method 300 may yield the binarized feature vector by adding one or more pad features 310, performing a M×M transform 320, and performing a quantization 325.

The method 300 may include transforming M floating point features 315 into M binary features 330, where an initial number of floating point features 305, N, are padded with features (e.g., with a number of “zero” features) as determined by M minus N.

Similar to what was discussed with respect to the system of FIG. 1, the method 300 may include identifying a source feature vector which may include N floating point features 305. Additional floating point features (M-N—to be read as “M” minus “N”) 310 may be added to the original N floating point features 315 to result in a feature vector with M floating point features 315. A M×M transform may be applied to the feature vector 315 at block 320 and quantization of the transformed feature vector may be performed at block 325 to result in M binary features 330, B. The M binary features may be organized as a bit sequence or bit pattern. Any number of floating point features may be transformed into any number of binary features.

In some embodiments, a length 340 of the N floating point features 305 may be determined. In some embodiments, the floating point features 305 are an entire feature vector and the length of the features is also the same as the length of the source feature vector. In some embodiments, the length of the source feature vector is distance from an origin. The length 340, L, may be stored in an electronic storage.

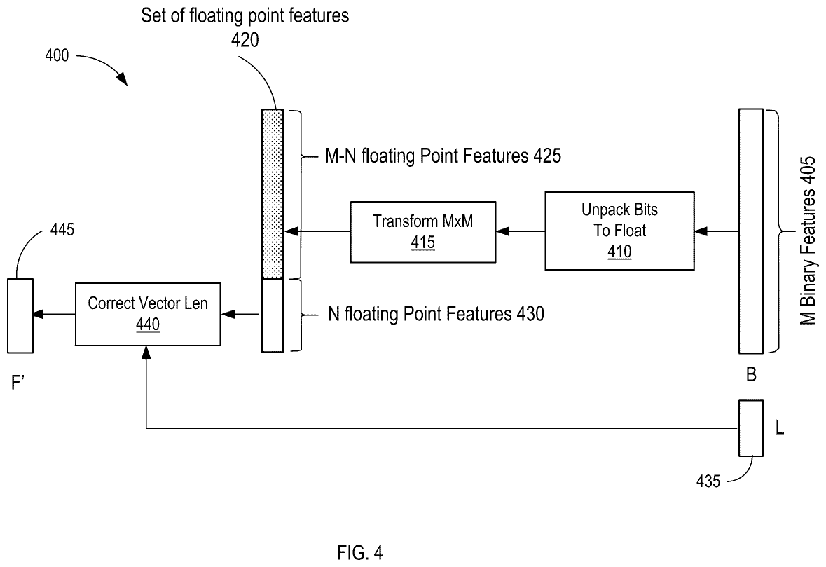

FIG. 4 illustrates a schematic view of an example method 400 for converting M binary features to an approximation of a source feature vector, F′, 445 with N floating point features 430. The method 400 may identify M binary features in one or more bits, which may be referred to a binarized feature vector. At block 410, the method may include unpacking the M bits to floating point values, such as by using an “unpack bits to float” operation. In example, a binary value of 1 can be expanded to a floating point value of 1.0 and a binary value of 0 can be expanded to a floating point value of −1.0. At block 415, the method 400 may include performing an M×M transform operation on the floating point values to obtain a set of floating point features 420. The M×M transform may include an inverse transform, which may be an inverse transform with respect to a particular transform that was applied to the source feature vector.

The set of floating point features 420 may include M-N floating point features 425 and N floating point features 430. To determine a division of the set of floating point features 420 into the M-N floating point features 425 and the N floating point features 430, the method may include obtaining a length 435, L, of the source feature vector. Using that length 435, L, at block 440, the method may extract the N floating point features 430 from the set of floating point features 420. The extracted N floating point features 430 may be identical to, or an approximation of, the source feature vector 445 that was previously binarized. In this regard, the vector length can be used to perform an inverse transfer function to reconstruct the feature vector as the feature vector existed prior to the transform.

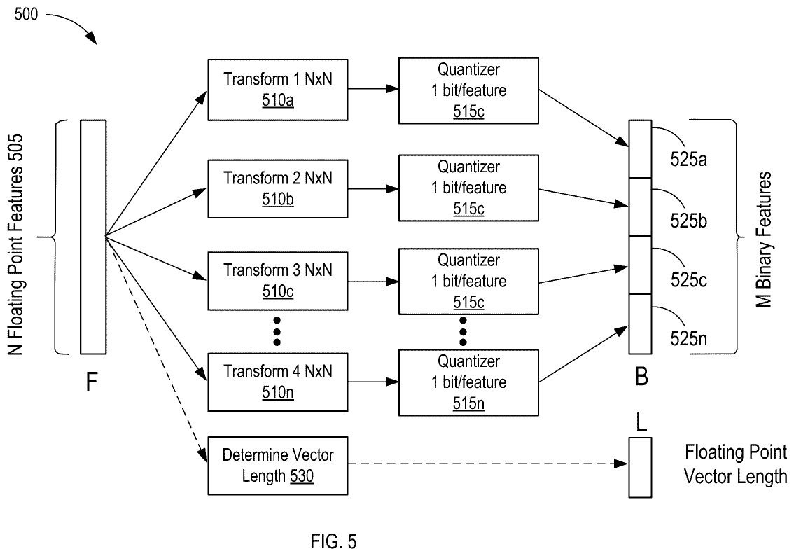

FIG. 5 illustrates a schematic view of an example system 500 for generating M binary features 525a-n using multiple transforms 510a-n and/or quantizations 515a-n from N floating point features 505. In some embodiments, the method 500 may include transforming N floating point features of a feature vector 505 into binary. As illustrated for example, FIG. 5 shows a technique for transforming 4×N floating point features to M binary features. Any number of floating point features may be transformed into any number of binary features.

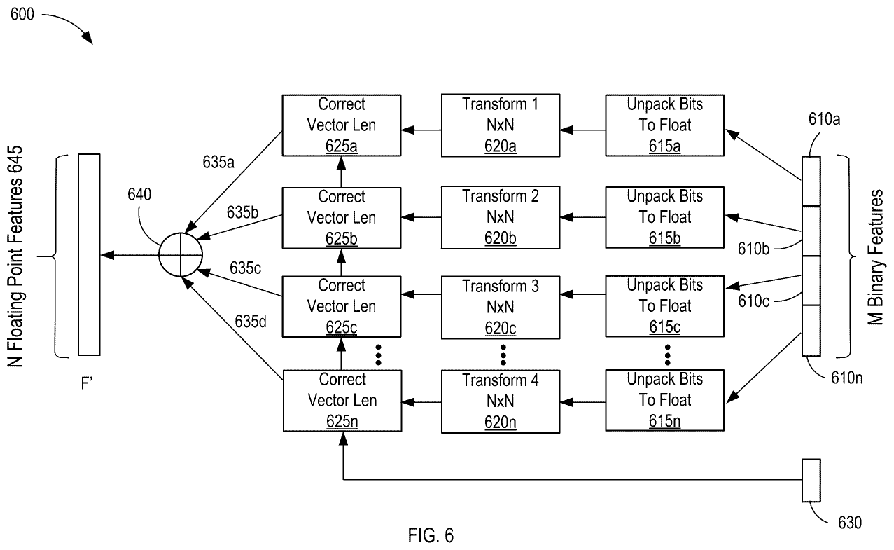

FIG. 6 illustrates a schematic view of an example system 600 for converting M binary features 610a-n to N floating point features 645 using multiple transforms. The system 600 may perform a method for reversing M binary features 610a-n into of a feature vector with N floating point features 645 and, for example, can be used to reverse the feature vector binarization of FIG. 5 (e.g., to reconstruct a source feature vector, or an approximation of the source feature vector). As illustrated for example, FIG. 6 shows a technique for reversing M binary features 610a to a feature vector of 4×N floating point features 645. Any number of binary features 610 may be transformed into any number of floating point features 645. In some embodiments, the Transform 1 at block 620a may be the inverse of Transform 1 at block 510a in FIG. 5. Moreover, the Unpack Bits to Float blocks 615a-n may take each bit in the binary representation 610 and may, for example, assign a float value of +1.0 if the bit value is 1 or a float value of −1.0 if the bit value is 0. The magnitude of these values may be ignored in some embodiments, while the sign may be preserved and retained since the magnitude may be corrected during the “Correct Vector Len” blocks 625a-n. The output of each of the “Correct Vector Len” blocks 625a-n is a floating point value 635a-n, which are combined to yield the N floating point features 645.

FIG. 7A illustrates an example 700 projection of a feature vector 710 from a lower dimension coordinate system 705 onto a single higher dimension coordinate system 715. To produce an M dimensional binary feature vector, an N bit floating point feature vector may be padded to M dimensions and a single M×M rotational transform is performed This single transform provides additional axes 715 to project the original N dimensional feature vector 710 onto, which has the same or similar effect of increasing the entropy resolution. The example shows a technique applied to convert a 1D feature to 2D feature space. The coordinate system 705 is initially 1 dimension (vertical) and adding a padding feature with a zero value makes the feature vector 2D, as illustrated with axis 720 (dashed axis), but with no information associated with the new dimension.

In an example, the feature vector 710 may be padded with additional features and the additional features may be initially set to zero. When the feature vector (with the padding) is transformed, the “zeros” may be transformed into “non-zeros” and may assume some portion of the feature vector entropy, thus increasing the entropy resolution.

A single 2D transformation is then applied to the padded feature vector, which spreads the entropy associated with feature F onto 2 dimensions as F₀ and F₁. In an example, a dimension feature vector may be padded to be a 12 dimension feature vector. The 12 dimensions may add more resolution and may allow more information to be captured. In an example embodiment, single bit quantizing F₀ and Fᵢ using a threshold of zero may produce a 2D binary feature vector: 10.

FIG. 7B illustrates a 2 dimensional example 750 of the same feature of FIG. 7A being projected onto two different coordinate axes 755, 765. In an example, quantizing to the axis 755 (aligned to the horizontal and vertical) will produce binary values of 11. Quantizing the feature vector 710 to the tilted axis 765 (not aligned to the horizontal and vertical) will produce binary values of 00. Together they provide better resolution of the entropy contained in the original feature vector 710.

To further illustrate the improvement in entropy resolution from this expansion, each of the 8 slices created by the combination of the first axis 755 and the tilted axis 765 may create a different bit pattern. So, increasing the dimension in this way may reduce the amount of feature space that each bit pattern represents (or in other words reduces the size of the slice of feature space each bit pattern represents). With the first axis 755 there are 4 quantization regions, but with both the first and tilted axes 755, 765, there are 8 quantization regions covering the same feature space. Effectively, this is quantizing the feature space angularly, which also shows why the process may not be fully reversible without the vector length. As illustrated, the axis 755 and the tilted axis 765 share the same origin, but the axis 755 can have an origin that is different than an origin for the tilted axis 765. For translated axes (e.g., moving an origin of an axes to a new point without changing the direction of the axes), the behavior can be the same. For example if the tilted axis 765 were translated to have an origin at a different location than the first axis 755, the projection would still be made onto x and y axes of the translated axis 765 in the same or similar manner described for non-translated axes. The values of F′1 and F′2 may be different than what is shown due to the translation, but the process of projection may be the same. As an example, in a scenario where the origin of the translated axis 765 is shifted along its y axis, a value of F′1 would stay the same, but the value of F′2 would become larger or smaller depending on the direction of the shift. Likewise, for a shift along the x axis, F′2 would stay the same, but F′1 would change.

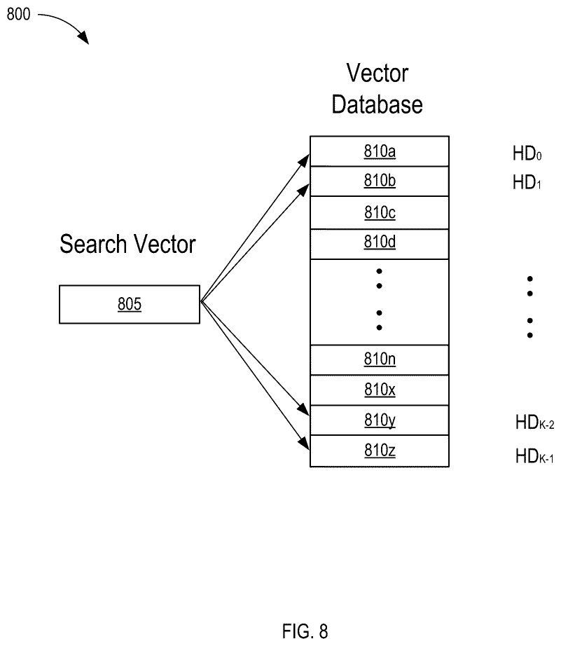

FIG. 8 illustrates an example diagram 800 for using a search vector 805 in view of a vector database of vectors 810 to determine one or more distances. In an example, a binarized feature vector 805 can be used for searching, such as to find matches of any type of data. In some embodiments, a full binarized feature vector 805 can be used to search a vector database 810 for a match. If a match is found, then it can be determined that a similarity may exist between the source feature vector (that was binarized and then used as the search vector 805) and the search result.

Since the feature vector may represent any type of object, the matching process may be used to identify a particular object. For example, in addition to biometrics, a feature vector may represent a photo of a location. A match as a result of a search using the binarized feature vector of the photo may lead to a positive identification of the location. For example, a photo of an unknown location may be used to determine the actual location where the photo was taken. In another example, a match may indicate that a photo is of an actual location that exists in the real world, as opposed to an artificially generated image of a make-believe location. Further, the present disclosure may be used for multimodal situations, where a feature vector may represent a combination of images, text, etc. in the same vector space, with any number of dimensions.

Matching, for example, may be performed with an exclusive or operation between the two binary feature vectors and counting the 1 bits (bits that differ). Searching a full database of binary feature vectors 810 can be performed quickly with a Hamming distance measure, for example.

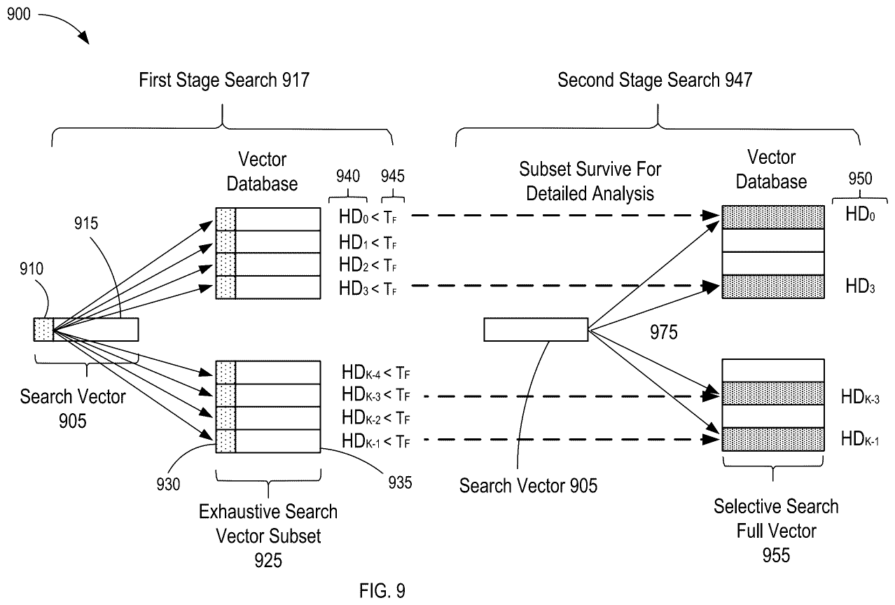

FIG. 9 illustrates a schematic view of an example system 900 for performing a two-stage search of a vector database 925. The match speed of system 800 of FIG. 8 can be further enhanced through two stage matching according to FIG. 9. In some embodiments, less than the entire binarized feature vector 805 can be used to search a vector database for a match. For example, binary feature vectors 905 can be partially searched, e.g., using only a portion of the bit sequence, illustrated as 910. In some embodiments, a partial search may not need a separate hashing algorithm. Distribution of entropy across the binary features allows a faster lower entropy search to be performed with a subset of the binary feature vector.

As illustrated, a fast first stage 917 using the first j bits of the vector 910. Search results or comparisons between 910 and 930 with associated Hamming distances 940 below a selected threshold TF 945 are passed to the second stage 947. A second stage search 947 performs full vector match on selected subset of the search vector 975, which are represented in FIG. 9 by the shaded boxes 975.

Typically the binary representation produces a compression as compared to the full floating point feature vector. Often 2-8 bits per feature provides sufficient accuracy, which can be a 4×-16× compression in the stored template size. In some embodiments, the number of bits selected for the first stage search 917 is representative of a fraction or percentage of the total length of the feature vector, for example between 10-25% of the length. In some embodiments, the number of bits for the first stage search 917 are selected based on hardware characteristics, for example, related to a number and/or length of registers in a processor, etc.

The Hamming distance of the binary features can be calculated very fast in parallel by a simple XOR( ) and a population count (popcnt) operation.

As illustrated in FIG. 9, the two search stages are shown as being separated, but in many cases the searches can be performed more efficiently using an inline two stage matching approach. In this embodiment, the Hamming distance is first determined over the first N bits (stage 1 binary vector size). If the Hamming distance is below a threshold, then the Hamming distance of the remaining M-N bits (M being the total number of bits in the binary vector) is determined and added to the first stage Hamming distance measurement to get the full vector Hamming distance value. If the Hamming distance after the first N bits is above the threshold, the candidate is marked as non-matching and the remainder of the calculation is not performed. This may be more efficient since the first N-bits are not recalculated for each stage and the processor cache is better utilized. This can be expanded to N stages, however in some embodiments, there may be some inefficiency caused by having to stop to check the partial result, so too many stages may disrupt the program flow and cause the search to slow down.

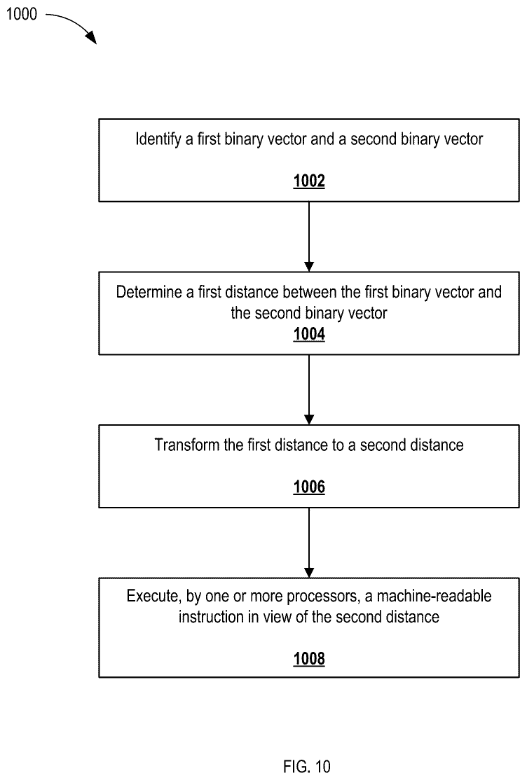

FIG. 10 illustrates a flowchart of an example method 1000 of performing binary distance transform, in accordance with at least one embodiment of the present disclosure. The method 1000 may be performed by processing logic that may include hardware (circuitry, dedicated logic, etc.), software (such as is run on a computer system), or a combination of both, which processing logic may be included in any computer system or device.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 1002, the processing logic may identify a first binary vector and a second binary vector. The first binary vector and the second binary vector may both have a binary dimension M, the binary dimension indicating a number of bits.

At block 1004, the processing logic may determine a first distance between the first binary vector and the second binary vector. The first distance may include a count of differing bits between the first binary vector and the second binary vector.

At block 1006, the processing logic may transform the first distance to a second distance. Transforming the first distance to the second distance may include determining a mapping function between the first distance and the second distance. Determining the mapping function between the first distance and the second distance may be based on at least one of a type of source data, or on binary dimension M. The mapping function between the first distance and the second distance may be trained from sample data. The sample data may include information related to a more than one feature vectors, and a corresponding binarized feature vector for each feature vector of the feature vectors.

In some embodiments, transforming the first distance to a second distance includes identifying a first vector length related to the first binary vector, identifying a second vector length related to the second binary vector, and determining the second distance using the first vector length and the second vector length. The first distance may include a Hamming distance between the first binary vector and the second binary vector and the second distance may include a Euclidean distance between the first vector and the second vector.

In some embodiments, transforming the first distance to a second distance includes transforming the Hamming distance to a cosine similarity; and transforming the cosine similarity to the Euclidean distance. In some embodiments, transforming the first distance to a second distance includes at least one of transforming a Hamming distance to a cosine similarity, or transforming the Hamming distance to a Euclidean distance.

In some embodiments, transforming the first distance to a second distance includes normalizing the count of differing bits as a floating point number to approximate a cosine similarity value, the normalizing being based on the length M and the count of differing bits between the first binary vector and the second binary vector. In some embodiments, the normalizing is executed as a normalization between-1 and +1.

At block 1008, the processing logic may execute a machine-readable instruction in view of the second distance. For example, the machine-readable instruction may include at least one of: a comparison, a search, or a sort operation. In some examples, executing the search includes performing a two-stage search, such as a two-stage search according to FIG. 9.

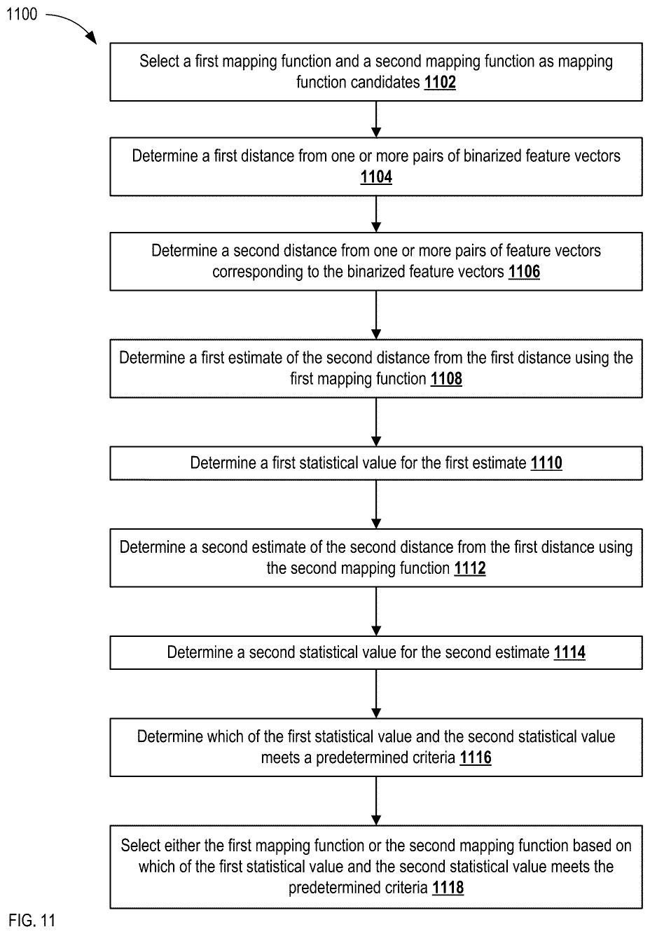

FIG. 11 example process for determining the mapping between the first distance and the second distance. At block 1102, the processing logic may select a first mapping function and a second mapping function as mapping function candidates. At block 1104, the processing logic may determine a first distance from one or more pairs of binarized feature vectors. At block 1106, the processing logic may determine a second distance from one or more pairs of source feature vectors corresponding to the binarized feature vectors. At block 1108, the processing logic may determine a first estimate of the second distance from the first distance using the first mapping function. At block 1110, the processing logic may determine a first statistical value for the first estimate. At block 1112, the processing logic may determine a second estimate of the second distance from the first distance using the second mapping function. At block 1114, the processing logic may determine a second statistical value for the second estimate. At block 1116, the processing logic may determine which of the first statistical value and the second statistical value meets a predetermined criteria. At block 1118, the processing logic may select either the first mapping function or the second mapping function based on which of the first statistical value and the second statistical value meets the predetermined criteria. In some embodiments, the first distance includes a Hamming distance and the second distance includes a cosine similarity.

FIG. 12 illustrates a diagrammatic representation of a machine in the example form of a computing device 1200 within which a set of instructions, for causing the machine to perform any one or more of the methods discussed herein, may be executed. The computing device 1200 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 1200 includes a processing device (e.g., a processor) 1202, a main memory 1204 (e.g., read-only memory (ROM), flash memory, dynamic random access memory (DRAM) such as synchronous DRAM (SDRAM)), a static memory 1206 (e.g., flash memory, static random access memory (SRAM)) and a data storage device 1216, which communicate with each other via a bus 1208.

Processing device 1202 represents one or more general-purpose processing devices such as a microprocessor, central processing unit, or the like. More particularly, the processing device 1202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also include one or more special-purpose processing devices such as an application specific integrated circuit (ASIC), a field programmable gate array (FPGA), a digital signal processor (DSP), network processor, or the like. The processing device 1202 is configured to execute instructions 1226 for performing the operations and steps discussed herein.

The computing device 1200 may further include a network interface device 1222 which may communicate with a network 1218. The computing device 1200 also may include a display device 1210 (e.g., a liquid crystal display (LCD) or a cathode ray tube (CRT)), an alphanumeric input device 1212 (e.g., a keyboard), a cursor control device 1214 (e.g., a mouse) and a signal generation device 1220 (e.g., a speaker). In at least one embodiment, the display device 1210, the alphanumeric input device 1212, and the cursor control device 1214 may be combined into a single component or device (e.g., an LCD touch screen).

The data storage device 1216 may include a computer-readable storage medium 1224 on which is stored one or more sets of instructions 1226 embodying any one or more of the methods or functions described herein. The instructions 1226 may also reside, completely or at least partially, within the main memory 1204 and/or within the processing device 1202 during execution thereof by the computing device 1200, the main memory 1204 and the processing device 1202 also constituting computer-readable media. The instructions may further be transmitted or received over a network 1218 via the network interface device 1222.

While the computer-readable storage medium 1226 is shown in an example embodiment to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

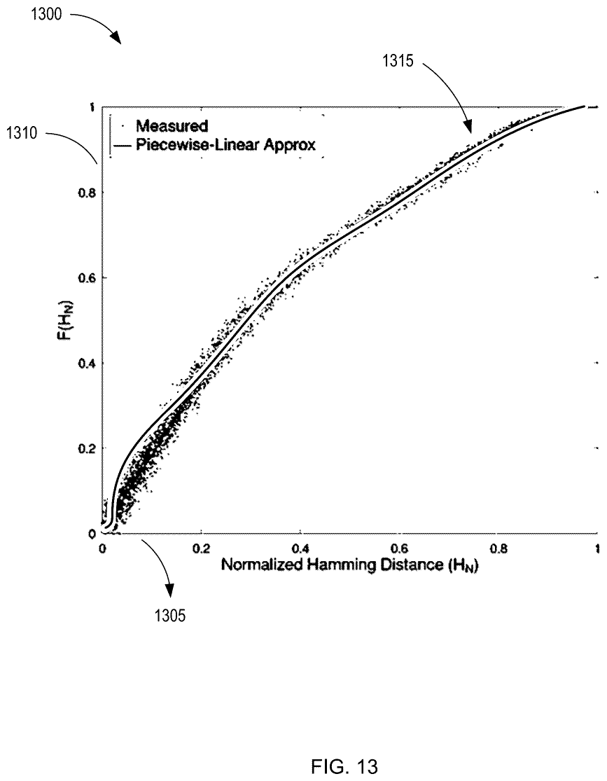

FIG. 13 illustrates a diagram 1300 of an example mapping function F(H_{N}). The data points shown in the plot are measured values of F(H_{N}) and the black line shows a piecewise linear model of the function. As illustrated, F(H_{N}) is also an approximation of the mapping from Hamming distance to cosine similarity between the two vectors, so this function may be used to provide an approximation of the cosine similarity.

Hamming distance can also be used to determine an approximation for the Euclidean Distance between original floating point feature vectors as well as for Cosine Similarity.

In some embodiments, a normalized correlation or cosine similarity measurement can be determined or approximated. For Euclidean features, Hamming distance alone may not adequately approximate Euclidean distance. However, if the lengths of the two vectors (L₀ and L₁) being compared are also available, the Euclidean distance can be approximated as follows:

$$E = sqrt ( {L}_{0} * {L}_{0} + {L}_{1} * {L}_{1} - 2 * {L}_{0} * {L}_{1} * F ( {H}_{N} ) )$$

where H_{N} is the normalized Hamming distance given by: H_{N}=1−2*H/N, where H is the integer Hamming distance and N is the number of bits in the binary vector.

To calculate the Euclidean distance, the magnitude of the vector may be used. In some embodiments, a Euclidean distance measurement can be performed using the vector length.

In other embodiments, the mapping function illustrated in FIG. 13 can be approximated in other ways, such as using a Taylor series or other non-linear approximation techniques. The function may also vary in shape slightly depending on the binary vector length N.

In some embodiments, resolution of the quantization can be increased or decreased to meet system performance needs. The same feature vector can serve as a faster more approximate match, followed by a slower more accurate over an identified subset of the full data set.

A number of implementations have been described. Nevertheless, it will be understood that various modifications may be made without departing from the spirit and scope of the disclosure. Accordingly, other implementations are within the scope of the following claims.

Modifications, additions, or omissions may be made to any system or method described herein without departing from the scope of the present disclosure. For example, the designations of different elements in the manner described is meant to help explain concepts described herein and is not limiting. Further, the systems or methods may include any number of other elements or may be implemented within other systems or contexts than those described. For example, any of the components may be divided into additional or combined into fewer components.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
identifying a feature vector with N features to transform into M bits, the feature vector including a plurality of values, each value of the plurality of values corresponding to a characteristic of an object;
applying a transform to the feature vector to create a transformed feature vector;
quantizing the transformed feature vector to generate a binarized feature vector of M bits; and
storing, in an electronic data storage, the binarized feature vector.

2. The method of claim 1, further comprising adjusting a number of dimensions of the feature vector to M dimensions.

3. The method of claim 1, wherein applying the transform to the feature vector to create the transformed feature vector includes applying multiple transforms.

4. The method of claim 2, wherein adjusting the number of dimensions of the feature vector to M dimensions includes appending one or more padding features to the feature vector.

5. The method of claim 4, wherein applying the transform to the feature vector includes applying the transform to the M dimensional feature vector that includes the N features of the feature vector and one or more padding features.

6. The method of claim 4, wherein the number of dimensions of the feature vector is increased to M dimensions prior to applying the transform to the feature vector.

7. The method of claim 1, wherein applying the transform to the feature vector includes applying the transform to each value of the plurality of values to provide a plurality of transformed feature values, the transformed feature vector including the plurality of transformed feature values, wherein the quantizing yields one bit for each transformed feature value.

8. The method of claim 1, wherein the quantizing yields more than one bit for each transformed feature value.

9. The method of claim 1, further comprising determining a vector length of the feature vector, wherein the vector length to be used to perform an inverse transfer function to reconstruct an approximation of the feature vector as the feature vector existed prior to the transform.

10. The method of claim 1, wherein the transform is selected from a group of transforms in view of at least one of a vector size or an entropy resolution.

11. The method of claim 1, wherein N equals 1.

12. A system, comprising:
one or more processors; and
a memory comprising instructions that, when executed by the one or more processors, cause the system to perform operations comprising:
identify a feature vector with N features to transform into M bits, the feature vector including a set of values, each value of the set of values corresponding to a characteristic of an object;
apply a transform to the feature vector to create a transformed feature vector;
quantize the transformed feature vector to generate a binarized feature vector of M bits; and
cause the binarized feature vector to be stored electronically.

13. The system of claim 12, wherein the feature vector is associated with a feature space, the feature space being a dimensional space comprising one or more of dimensions, the feature space having N axes, each feature of the N features being represented as a point in the feature space with respect to the N axes.

14. The system of claim 12, wherein the feature vector is an N-dimension feature vector, the operations further including to add another dimension to the feature vector to result in a higher-dimension feature vector, wherein the transform is applied to the higher-dimension feature vector.

15. The system of claim 14, wherein when adding the another dimension to the feature vector, the system is to add a padding to the feature vector, wherein the padding includes a zero value, wherein the applying the transform to the N-dimension vector results in the zero value transforming to a non-zero value.

16. The system of claim 14, wherein when adding the another dimension to the feature vector, the system is to apply multiple transforms to the feature vector.

17. The system of claim 14, wherein N equals 1.

18. The system of claim 14, wherein N is greater than one, wherein when adding the another dimension to the feature vector, the system is to:
define a first sub-vector and a second sub-vector from the feature vector;
apply a first transform to the first sub-vector to create a transformed first sub-vector;
apply a second transform to the second sub-vector to create a transformed second sub-vector; and
combine the transformed first sub-vector and the transformed second sub-vector to create the transformed feature vector having length M.

19. The system of claim 12, wherein the operations further comprising to determine a vector length of the feature vector, wherein the vector length to be used to perform an inverse transfer function to reconstruct the feature vector as the feature vector existed prior to the transform.

20. A non-transitory machine-storage medium embodying instructions that, when executed by a machine, cause the machine to perform operations comprising:
identify a feature vector with N features to transform into M bits, the feature vector including a plurality of values, each value of the plurality of values corresponding to a characteristic of an object;
apply a transform to the feature vector to create a transformed feature vector;
quantize the transformed feature vector to generate a binarized feature vector of M bits; and
cause the binarized feature vector to be stored electronically.

21. The non-transitory machine-storage medium of claim 20, wherein the feature vector includes one or more dimensions, the operations further including to add another dimension to the feature vector.

22. The non-transitory machine-storage medium of claim 20, wherein the feature vector is a sub-vector that is one part of a larger feature vector.
